(19) United States
(12) Patent Application Publication
(10) Pub. No.: US 2025/0301495 A1
(43) Pub. Date: Sep. 25, 2025

(54) Multi-Access Point Coordination Signal Transmission Method and System Capable of Improving Concurrent Communication Efficiency

(71) Applicant: MEDIATEK INC., Hsinchu City (TW)

(72) Inventor: Pochun Fang, Hsinchu City (TW)

(73) Assignee: MEDIATEK INC., Hsinchu City (TW)

(21) Appl. No.: 19/071,765

(22) Filed: Mar. 6, 2025

Related U.S. Application Data
(60) Provisional application No. 63/569,256, filed on Mar. 25, 2024.

(51) Int. Cl. H04W 74/00; H04L 5/00; H04W 74/0816

(52) U.S. Cl. CPC H04W 74/002; H04L 5/0053; H04W 74/0816

(57) ABSTRACT

A multi-access point coordination signal transmission method includes receiving a coordination control frame transmitted from a first access point (AP) by a second AP, decoding and parsing the coordination control frame by the second AP during a short interframe space, transmitting a leading signal from a second AP to a second station when a first packet protocol data unit (PPDU) is transmitted from the first AP to a first station, entering an idle state by the second station after the leading signal is completely received, and receiving a second PPDU transmitted from the second AP by the second station after leaving the idle state

### CROSS REFERENCE TO RELATED APPLICATIONS

This application claims the benefit of U.S. Provisional Application No. 63/569,256, filed on Mar. 25, 2024. The content of the application is incorporated herein by reference.

### BACKGROUND

Wireless Local Area Networks (WLANs) are essential for high-speed wireless internet access. The IEEE 802.11 standard, specifically the amendments from 802.11be (Wi-Fi 7) to 802.11bn (Wi-Fi 8), leverages multi-access point (M-AP) coordination schemes to enhance performance and reliability. These M-AP coordination schemes, including coordinated spatial reuse (CSR), coordinated beam-forming (CBF), and coordinated time division multiple access (TDMA), are used for allowing access points (APs) to cooperate and share resources, such as transmission opportunities (TxOPs), thereby optimizing network efficiency and user experience. These schemes typically involve a sharing AP that shares its TxOP with one or more shared APs. The sharing AP uses an M-AP Trigger frame to notify the shared APs about the coordinated transmission, which includes timing information, allocation, and power control. The shared APs then transmit concurrently on the overlapping primary channel to gain extra transmission opportunities and improve throughput and latency.

However, it is crucial but challenging to align the start time of the shared AP's transmission with that of the sharing AP's transmission after receiving the M-AP Trigger frame. This strict timing requirement poses difficulties in implementation and requires precise timing control. One alternative solution is to introduce a delay in the shared AP's transmission to allow more time for preparation. However, this approach may require the shared AP's associated stations (STAs) to support specific capabilities, such as Packet on Packet (PoP) detection. PoP detection allows an STA to terminate its ongoing reception and switch to decode the desired packet of another PPDU. Unfortunately, not all STAs support PoP detection, and implementing this capability can be complex and limited.

Therefore, a solution is needed that enables efficient and reliable coordinated transmission without relying on specific STA capabilities.

### SUMMARY

In an embodiment, a multi-access point (M-AP) coordination signal transmission method is disclosed. The M-AP coordination signal transmission method comprises receiving a coordination control frame by a second access point (AP), wherein the coordination control frame is transmitted from a first AP, decoding and parsing the coordination control frame by the second AP during a short interframe space (SIFS), transmitting a leading signal from a second AP to a second station when a first packet protocol data unit (PPDU) is transmitted from the first AP to a first station, entering an idle state by the second station after the leading signal is completely received, and receiving a second PPDU transmitted from the second AP by the second station after leaving the idle state.

In another embodiment, an M-AP coordination signal transmission system is disclosed. The M-AP coordination signal transmission system comprises a first AP, a second AP linked to the first AP and configured to coordinate with the first AP, a first station linked to the first AP, and a second station linked to the second AP. The second AP receives a coordination control frame. The coordination control frame is transmitted from the first AP. The second AP decodes and parses the coordination control frame during a SIFS. The second AP transmits a leading signal to the second station when a first PPDU is transmitted from the first AP to the first station. The second station enters an idle state after the leading signal is completely received. The second station receives a second PPDU transmitted from the second AP after leaving the idle state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a multi-access point (M-AP) coordination signal transmission system according to an embodiment of the present invention.

FIG. 2 is an architecture diagram of a first access point and a second access point of the M-AP coordination signal transmission system in FIG. 1.

FIG. 3 is a schematic diagram of signal sequences of the M-AP coordination signal transmission system in FIG. 1.

FIG. 4 is a flow chart of performing an M-AP coordination signal transmission method by the M-AP coordination signal transmission system in FIG. 1.

### DETAILED DESCRIPTION

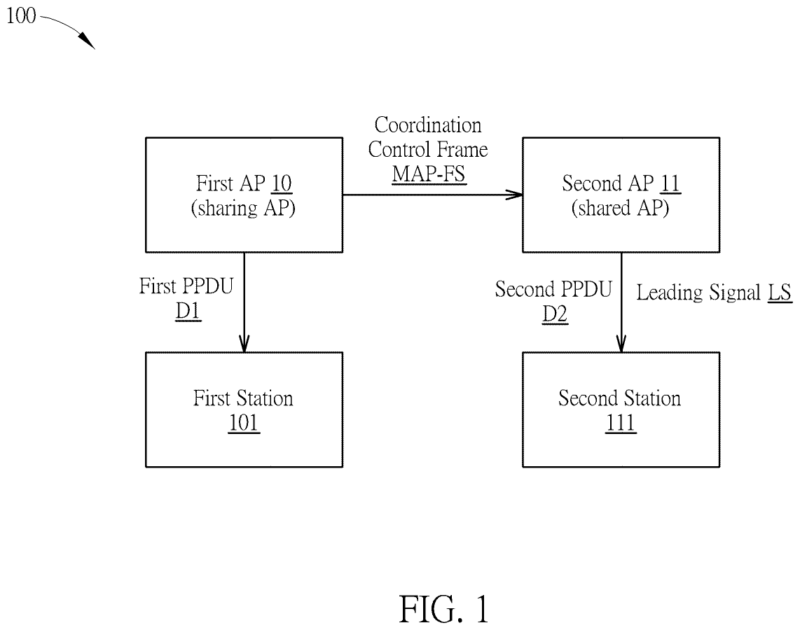

FIG. 1 is a block diagram of a multi-access point (M-AP) coordination signal transmission system 100 according to an embodiment of the present invention. The M-AP coordination signal transmission system 100 is designed to improve the efficiency of concurrent communication in multi-access point networks, such as those operating under the IEEE 802.11be (Wi-Fi 7) to 802.11bn (Wi-Fi 8) standards. The system addresses the challenge of aligning the start time of shared AP transmissions with that of the sharing AP, which is crucial for achieving high throughput and low latency in coordinated spatial reuse (CSR), coordinated beam-forming (CBF), and coordinated time division multiple access (TDMA) schemes.

In FIG. 1, the M-AP coordination signal transmission system 100 includes a first access point (AP) 10, a second AP 11, a first station 101, and a second station 111. The first AP 10, also referred to as the sharing AP, is a key component of the M-AP coordination signal transmission system 100. It is designed to share its transmission opportunity (TxOP) with other devices, enabling coordinated transmission and improved network efficiency. The first AP 10 is linked to the second AP 11 under a Wi-Fi network. Further, the first AP 10 can also communicate with at least one station, such as the first station 101. The TxOP is a time interval during which a station in the Wi-Fi network can transmit data frames. For example, APs can allocate their TxOPs to different stations to manage the shared wireless medium and ensure fair access. The duration of the TxOP can vary depending on factors such as the station's data rate, the type of frame being transmitted, and the network conditions. The second AP 11 is linked to the first AP 10 for coordinating with the first AP 10. The second AP 11 is a shared AP for using a portion of the shared TxOP provided from the first AP 10 and adjusting its transmission parameters accordingly. This is achieved through a coordination control frame MAP-FS which carries mandatory information like timing, allocation, and transmission power control. The second AP 11 can also communicate with at least one station, such as the second station 111.

The first station 101 is a wireless communication device that is linked to the first AP 10. It is typically a user device such as a laptop, smartphone, or tablet. The first station 101 receives data packets from the first AP 10 in the form of PPDU (Packet Protocol Data Unit), such as the first PPDU D1 in FIG. 1. The second station 111 is another wireless communication device that is linked to the second AP 11. It is also typically a user device such as a laptop, smartphone, or tablet. The second station 111 receives data packets from the second AP 11 in the form of PPDU, such as the second PPDU D2 in FIG. 1. The PPDU is the fundamental unit of data transmission in Wi-Fi networks. It encapsulates the data payload along with necessary headers and control information. The PPDU structure is defined in the IEEE 802.11 standard, which outlines the specific format and fields within the PPDU. The format of the PPDU can vary depending on the type of data being transmitted and the specific 802.11 amendment being used. In one embodiment, the PPDU can include the data payload, MAC headers, and control information. The MAC header includes information such as the source and destination addresses, frame control information, and other control fields. The control information within the PPDU may include information related to timing, allocation, and power control, especially in the context of M-AP coordination.

In FIG. 1, the “leading signal LS” is a frame transmitted by the second AP 11 to the second station 111. The leading signal LS can be any type of frame, such as a clear-to-send-to-self (CTS-to-Self) frame, a control frame, a management frame, or a data frame. The leading signal can also be a physical layer convergence procedure (PLCP) header only frame, a null data frame, or a legacy-short training field (L-STF) signal. The L-STF signal consists of any Wi-Fi or non-Wi-Fi signal that begins with an L-STF symbol as defined by the 802.11 specification. Further, the leading signal LS is used for aligning the start time of the second AP's transmission with that of the first AP's transmission. This alignment is important for achieving high throughput and low latency in the coordinated spatial reuse (CSR), coordinated beam-forming (CBF), and coordinated time division multiple access (TDMA) schemes. In the M-AP coordination signal transmission system 100, the second AP 11 decodes and parses the coordination control frame MAP-FS during an SIFS (Short Interframe Space) after receiving it. The SIFS is the shortest time interval defined in the IEEE 802.11 standard, specifically the 802.11be (Wi-Fi 7) to 802.11bn (Wi-Fi 8) amendments. SIFS ensures the completion of critical tasks, such as decoding and parsing the coordination control frame MAP-FS, before the next transmission can occur. SIFS is used to ensure that devices have enough time to process received frames and prepare for subsequent transmissions. In other words, SIFS is used to avoid collisions and ensure that data is transmitted reliably. The duration of SIFS is typically very short, on the order of microseconds, and its definition varies for different physical layers (PHYs) in the 802.11 standard. At the same time when the first PPDU D1 is transmitted from the first AP 10 to the first station 101, the second AP 11 transmits the leading signal LS to the second station 111. Upon completely receiving the leading signal LS, the second station 111 enters an idle state. After leaving the idle state, the second station 111 receives the second PPDU D2 transmitted from the second AP 11. Details of the M-AP coordination signal transmission system 100 are illustrated below.

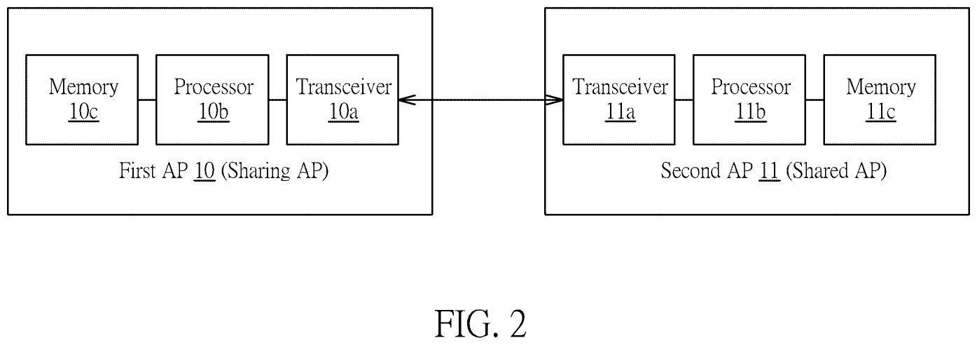

FIG. 2 is an architecture diagram of the first AP 10 and the second AP 11 of the M-AP coordination signal transmission system 100. The first AP 10 includes a transceiver 10a, a processor 10b, and a memory 10c. The transceiver 10a transmits the coordination control frame MAP-FS to the second AP 11 and transmits the first PPDU D1 to the first station 101. The memory 10c stores data and instructions necessary for the AP's operation, including the software programs that enable the transmission of the coordination control frame MAP-FS, facilitating communication with the second AP 11. The processor 10b can control the transceiver 10a and the memory 10c. The processor 10b can generate the coordination control frame MAP-FS, which includes information about the coordinated transmission parameters, such as timing information, allocation, and transmission power control. Further, the processor 10b can control the first AP 10 to generate the first PPDU D1, which can be received by the first station 101.

The second AP 11 includes a transceiver 11a, a processor 11b, and a memory 11c. The transceiver 11a enables the transmission and reception of data packets, allowing the second AP 11 to coordinate with the first AP 10 and communicate with its stations. The memory 11c stores data and instructions necessary for the AP's operation, including the software programs that enable the transmission of the leading signal LS, facilitating communication with the second station 111. The processor 11b can control the transceiver 11a and the memory 11c. The processor 11b can generate the leading signal LS. Further, the processor 11b can control the second AP 11 to generate the second PPDU D2, which can be received by the second station 111. In the M-AP coordination signal transmission system 100, the advantage of introducing the leading signal LS in the coordinated transmission scheme is that it eliminates the need for the second station 111 to support the Packet on Packet (PoP) functionality. PoP is a complex and resource-intensive feature that requires the station to terminate its ongoing reception and switch to decode a new packet. By aligning the start time of transmitting the leading signal LS by the second AP 11 with the start time of transmitting the first PPDU D1 by the first AP 10, the second station 111 can simply enter the idle state after receiving the leading signal LS and then switch to receive the desired packet of the second PPDU D2 transmitted from the second AP 11 without having to perform PoP. This simplifies the design of the second station 111 and reduces its power consumption. Details are illustrated below.

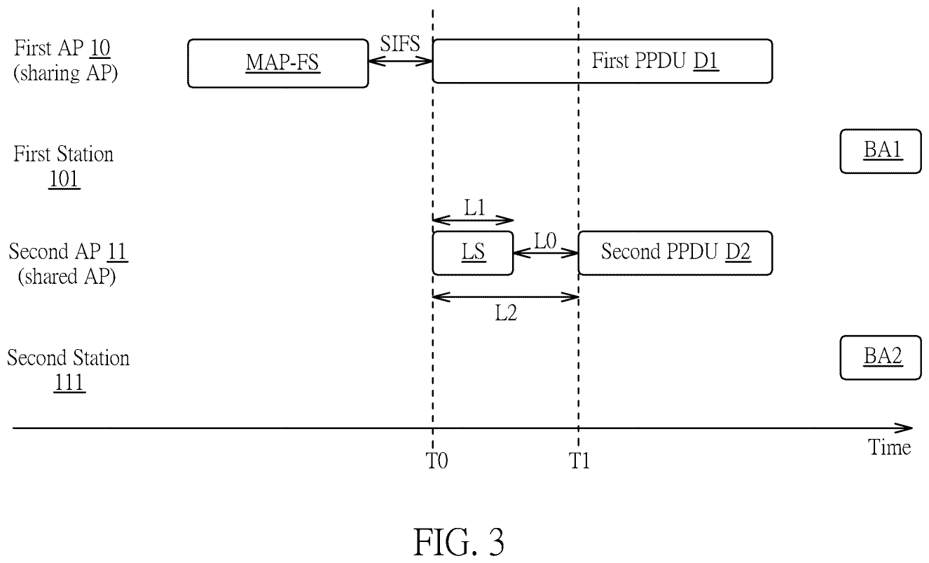

FIG. 3 is a schematic diagram of signal sequences of the M-AP coordination signal transmission system 100. As previously mentioned, the first AP 10 is a sharing AP for sharing its TxOP to other devices. The second AP 11 is a shared AP for using a portion of the shared TxOP provided from the first AP 10 to perform concurrent data transmission, and adjusting its transmission parameters accordingly. First, the first AP 10 transmits the coordination control frame MAP-FS to the second AP 11. The coordination control frame MAP-FS is used for initiating the first AP 10 as the sharing AP under M-AP coordination communications. Further, the coordination control frame is used for assigning the second AP 11 as the shared AP under the M-AP coordination communications. For example, the coordination control frame MAP-FS contains information about the first AP 10, such as its MAC address and its capabilities. The coordination control frame MAP-FS also contains information such as the timing and power control parameters. The second AP 11 uses the coordination control frame MAP-FS to configure itself for performing the M-AP coordination communications with the first AP 10.

After the coordination control frame MAP-FS is completely transmitted, there is the SIFS before the transmission of the first PPDU D1. SIF S is a very short time interval that is used to ensure that devices have enough time to process received frames and prepare for subsequent transmissions. In this embodiment, SIFS is used to allow the second AP 11 to decode and parse the coordination control frame MAP-FS and configure itself for the M-AP coordination communications. Once SIF S elapses, the first AP 10 starts to transmit the first PPDU D1 to the first station 101. The first PPDU D1 is a data frame that contains the data payload along with necessary headers and control information. The first station 101 receives the first PPDU D1 and decodes it to obtain the data payload. The second AP 11 can extract information of a start time T0 of transmitting the first PPDU D1 from the coordination control frame MAP-FS. Then, the second AP 11 can determine a time interval L1 of transmitting the leading signal LS based on the SIFS and the start time T0 of transmitting the first PPDU. In the embodiment, the start time of transmitting the leading signal LS is aligned with the start time T0 of transmitting the first PPDU D1. As a result, the second station 111 merely receives the leading signal LS when the first PPDU D1 is transmitted from the first AP to a first station. Specifically, merely receiving the leading signal LS prevents the second station 111 from performing PoP action, as illustrated below.

In conventional systems, if the second AP 11 (shared AP) transmits the second PPDU D2 with a delay, the second station 111 associated with second AP 11 needs to support a function called PoP detection. PoP is necessary to enable the second station 111 to terminate the reception of an ongoing unwanted frame (e.g., the first PPDU D1) and switch to decode the desired second PPDU D2 transmitted from its associated second AP 11. However, PoP detection adds complexity to second station 111 designs and may not be supported by all devices. To address this, in the M-AP coordination signal transmission system 100, the leading signal LS is transmitted by the second AP 11 with its start time aligned with the start time of the first PPDU D1 transmitted from the first AP 10. This leading signal LS acts as a trigger for the second station 111 to initially switch its reception state from the first PPDU D1 to the leading signal LS, eliminating the need for PoP detection. As a result, by aligning the start time of the leading signal LS with the first PPDU D1, the second station 111 can simply transition from receiving the leading signal LS to receiving its intended second PPDU D2 without PoP support.

In one embodiment, the leading signal LS can be a clear-to-send-to-self (CTS-to-Self) frame. After the CTS-to-Self frame is completely received by the second station 111, the second station 111 enters an idle state and waits for the second PPDU D2 of the second AP 11. The time length of the idle state is L0. The time length L0 of the idle state of the second station 111 is greater than or equal to the SIFS. After the second station 111 enters the idle state with the time length of L0, the second AP 11 starts to transmit the second PPDU D2 to the second station 111. The start time of transmitting the second PPDU D2 is T1. The second station 111 receives the second PPDU D2 and decodes it to obtain the data payload. Therefore, for the second station 111, the reception mechanism of the second PPDU D2, due to the introduction of the LS, will not be interfered with by the first PPDU D1. Further, in FIG. 2, L2 is a delay previously determined. The delay L2 is introduced to provide the second AP 11 with sufficient time to process the received coordination control frame MAP-FS. This delay L2 is essential to accommodate the processing time required by the second AP 11, ensuring that it can efficiently handle the coordination control frame MAP-FS and accurately align the leading signal LS with the start time of the first PPDU D1 transmitted by the first AP 10. In mathematical expression, the delay L2 can be represented as T1−T0, or L1+L0.

Further, in the M-AP coordination signal transmission system 100, the first station 101 generates a first block acknowledgement (Ack) signal BA1 after the first PPDU D1 is completely received by the first station 101. Similarly, the second station 111 generates a second block acknowledgement signal BA2 after the second PPDU D2 is completely received by the second station 111. The block acknowledgement signal is used for acknowledging the reception of a plurality of packets, typically PPDUs, with a single response frame. In the embodiment, the block acknowledgement signal (BA1 or BA2) is typically used for being sent after a certain number of PPDUs have been received or after a certain time interval has elapsed. In another embodiment, the first block acknowledgement BA1 and the second block acknowledgement signal BA2 can be omitted. Additionally, the precision of the aligned start time is intended to prevent the target receiving device from performing a packet detection (PD) hit on an unwanted frame from the device that sent the notification frame. This precision should be less than the duration of a single legacy-short training field (L-STF) symbol, which is 0.8 microseconds. In other words, in one embodiment, the second AP 11 generates the leading signal LS to align the start time of transmitting the first PPDU D1 by the first AP 10. The precision of aligning the leading signal LS with the start time of transmitting the first PPDU D1 is within 0.8 microseconds.

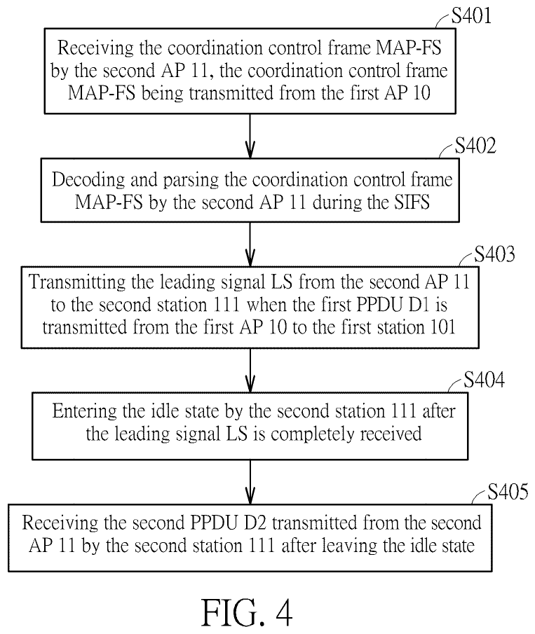

FIG. 4 is a flow chart of performing an M-AP coordination signal transmission method by the M-AP coordination signal transmission system 100. The M-AP coordination signal transmission method includes step S401 to step S405. Step S401 to step S405 are illustrated below.
Step S401: receiving the coordination control frame MAP-FS by the second AP 11, the coordination control frame MAP-FS being transmitted from the first AP 10;
Step S402: decoding and parsing the coordination control frame MAP-FS by the second AP 11 during the SIFS;
Step S403: transmitting the leading signal LS from the second AP 11 to the second station 111 when the first PPDU D1 is transmitted from the first AP 10 to the first station 101;
Step S404: entering the idle state by the second station 111 after the leading signal LS is completely received;
Step S405: receiving the second PPDU D2 transmitted from the second AP 11 by the second station 111 after leaving the idle state.

Details of step S401 to step S405 are previously illustrated. Thus, they are omitted here. The M-AP coordination signal transmission system 100 is used for enhancing the performance and reliability of the M-AP networks by coordinating the transmission of data packets from different APs. The system employs the leading signal LS to align the start time of data packets, which helps to reduce interference and improve overall network performance. Since no interference is introduced when PPDUs are received by stations, the M-AP coordination signal transmission system 100 provides a robust and efficient solution for coordinating transmissions in M-AP point environments, leading to improved network performance and compatibility.

In brief, in a coordinated transmission scenario, the first AP 10 initiates the process by winning contention and sending the coordination control frame MAP-FS to the second AP 11. The SIFS time gap precedes the actual data transmission (PPDU) and signals the second AP 11 to begin coordinated transmission. Upon receiving the coordination control frame MAP-FS transmitted from the first AP 10, the second AP 11 automatically generates the CTS-to-Self frame to the second station 111 within 0.8 microseconds, which is aligned with the start time of transmitting the first PPDU D1 of the first AP 10. As a result, the PoP functionality support is not mandatory for the second station 111, which is the target station for the second AP 11. This implies that the concurrent transmission behavior of the second AP 11 will not lead to IoT (Interoperability Testing) issues with the second station 111. In simpler terms, since the second station 111 is not required to support PoP, data transmission of the second AP 11 will not cause compatibility problems or malfunctions with the second station 111. This ensures a smooth and reliable communication between the second AP 11 and the second station 111, even with concurrent transmissions.

To sum up, the M-AP coordination signal transmission system of the embodiments has several advantages over conventional systems. First, it eliminates the need for stations to support the PoP functionality. PoP is a complex and resource-intensive feature that requires the station to terminate its ongoing reception and switch to decode a new packet. By aligning the start time of transmitting the leading signal with the start time of transmitting the PPDU, the station can simply enter the idle state after receiving the leading signal and then switch to receive the desired packet without having to perform the PoP function. This simplifies the design of the second station and reduces its power consumption. Second, since the system employs the leading signal to align the start time of data packets, it can reduce interference and improve overall network performance, leading to improved network performance and compatibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-access point (M-AP) coordination signal transmission method comprising:
receiving a coordination control frame by a second access point (AP), wherein the coordination control frame is transmitted from a first AP;
decoding and parsing the coordination control frame by the second AP during a short interframe space (SIFS);
transmitting a leading signal from a second AP to a second station when a first packet protocol data unit (PPDU) is transmitted from the first AP to a first station;
entering an idle state by the second station after the leading signal is completely received; and
receiving a second PPDU transmitted from the second AP by the second station after leaving the idle state.

2. The method of claim 1, wherein the coordination control frame is configured to initiate the first AP as a sharing AP under M-AP coordination communications, and the coordination control frame is configured to assign the second AP as a shared AP under the M-AP coordination communications.

3. The method of claim 1, further comprising:
extracting information of a start time of transmitting the first PPDU from the coordination control frame by the second AP; and
determining a time interval of transmitting the leading signal by the second AP according to the start time of transmitting the first PPDU and the SIFS.

4. The method of claim 3, wherein a start time of transmitting the leading signal is aligned with the start time of transmitting the first PPDU.

5. The method of claim 1, wherein the leading signal is a clear-to-send-to-self (CTS-to-Self) frame, a control frame, a management frame, a data frame, a physical layer convergence procedure (PLCP) header only frame, a null data frame, or a legacy-short training field (L-STF) signal.

6. The method of claim 1, further comprising:
merely receiving the leading signal by the second station when the first PPDU is transmitted from the first AP to a first station;
wherein merely receiving the leading signal prevents the second station from performing a packet on packet (PoP) action.

7. The method of claim 1, wherein a time length of the idle state of the second station is greater than or equal to the SIFS.

8. The method of claim 1, further comprising:
generating the leading signal by the second AP to align a start time of transmitting the first PPDU by the first AP;
wherein a precision of aligning the leading signal with the start time of transmitting the first PPDU is within 0.8 microseconds.

9. The method of claim 1, further comprising:
generating a first block acknowledgement (Ack) signal by the first station after the first PPDU is completely received by the first station; and
generating a second block Ack signal by the second station after the second PPDU is completely received by the second station.

10. The method of claim 1, wherein the first AP is a sharing AP configured to share its transmission opportunity (TxOP) to other devices, and the second AP is a shared AP configured to use a portion of the shared TxOP provided from the first AP for performing concurrent data transmission, and adjusting transmission parameters of the shared AP.

11. A multi-access point (M-AP) coordination signal transmission system comprising:
a first access point (AP);
a second AP linked to the first AP and configured to coordinate with the first AP;
a first station linked to the first AP; and
a second station linked to the second AP;
wherein the second AP receives a coordination control frame, the coordination control frame is transmitted from the first AP, the second AP decodes and parses the coordination control frame during a short interframe space (SIFS), the second AP transmits a leading signal to the second station when a first packet protocol data unit (PPDU) is transmitted from the first AP to the first station, the second station enters an idle state after the leading signal is completely received, and the second station receives a second PPDU transmitted from the second AP after leaving the idle state.

12. The system of claim 11, wherein the coordination control frame is configured to initiate the first AP as a sharing AP under M-AP coordination communications, and the coordination control frame is configured to assign the second AP as a shared AP under the M-AP coordination communications.

13. The system of claim 11, wherein the second AP extracts information of a start time of transmitting the first PPDU from the coordination control frame, and the second AP determines a time interval of transmitting the leading signal according to the start time of transmitting the first PPDU and the SIFS.

14. The system of claim 13, wherein a start time of transmitting the leading signal is aligned with the start time of transmitting the first PPDU.

15. The system of claim 11, wherein the leading signal is a clear-to-send-to-self (CTS-to-Self) frame, a control frame, a management frame, a data frame, a physical layer convergence procedure (PLCP) header only frame, a null data frame, or a legacy-short training field (L-STF) signal.

16. The system of claim 11, wherein the second station merely receives the leading signal when the first PPDU is transmitted from the first AP to a first station, and merely receiving the leading signal prevents the second station from performing a packet on packet (PoP) action.

17. The system of claim 11, wherein a time length of the idle state of the second station is greater than or equal to the SIFS.

18. The system of claim 11, wherein the second AP generates the leading signal to align a start time of transmitting the first PPDU by the first AP, and a precision of aligning the leading signal with the start time of transmitting the first PPDU is within 0.8 microseconds.

19. The system of claim 11, wherein the first station generates a first block acknowledgement (Ack) signal after the first PPDU is completely received by the first station, and the second station generates a second block Ack signal after the second PPDU is completely received by the second station.

20. The system of claim 11, wherein the first AP is a sharing AP configured to share its transmission opportunity (TxOP) to other devices, and the second AP is a shared AP configured to use a portion of the shared TxOP provided from the first AP for performing concurrent data transmission, and adjusting transmission parameters of the shared AP.
